(19) United States
(12) Patent Application Publication
(10) Pub. No.: US 2008/0008982 A1
(43) Pub. Date: Jan. 10, 2008

(54) Dental holder

(76) Inventor: Jonathan Carl Mursic, Bowmanville (CA)

Correspondence Address: Ralph A. Dowell of DOWELL & DOWELL P.C., 2111 Eisenhower Ave, Suite 406, Alexandria, VA, 22314, US

(21) Appl. No.: 11/709,876

(22) Filed: Feb. 23, 2007

Related U.S. Application Data
(60) Provisional application No. 60/775,793, filed on Feb. 23, 2006.

(51) Int. Cl. A61C 13/08

(52) U.S. Cl. 433/201.1

(57) ABSTRACT

An apparatus for holding a dental prosthesis during preparation of the dental prosthesis, the apparatus comprising: at least one base, the at least one base having an upper surface, at least one pin, and the at least one pin comprising a first end and a second end, the at least one pin further comprising a flared portion at the first end, and the first end extending beyond the upper surface of the at least one base, and the second end extending through and into the upper surface of the base. The use of an apparatus for holding a dental prosthesis during preparation of the prosthesis and for holding the dental prosthesis during firing without having to transfer the prosthesis to a second tray for firing. A method for preparing a dental prosthesis, the method comprising the steps of: a) mounting a substructure on an apparatus comprising at least one base, the at least one base having an upper surface, at least one pin, and the at least one pin comprising a first end and a second end, the at least one pin further comprising a flared portion at the first end, and the first end extending beyond the upper surface of the at least one base, and the second end extending through and into the upper surface of the base, b) applying at least one layer of ceramic to prepare a dental prosthesis, and c) firing the prosthesis mounted on the apparatus in a furnace.

### FIELD OF THE INVENTION

This invention relates to a dental holder firing platform apparatus to hold a dental prosthesis or substructure for preparation of a dental prosthesis. This invention further relates to a dental holder firing platform which can be used both as a dental holder and as a firing tray or platform thereby eliminating the need to transfer the final prepared dental prosthetic from a holding tray to a firing tray prior to firing the dental prosthesis in a furnace. The invention further relates to a method for preparing a dental prosthesis using a stand alone dental holder firing platform apparatus. The invention further relates to a pin for mounting a dental prosthesis on a dental holder.

### BACKGROUND OF THE INVENTION

Current devices and apparatus used in the application of porcelain in the preparation of a dental prosthesis require that the prosthesis be transferred from a holding device to a firing tray prior to firing in a furnace. This transfer step requires that the prosthesis be handled during the porcelain application in order to effect the transfer from the holder to the tray.

Current products that provide for holding the prosthesis while it is fired in a furnace have the disadvantage that the coping must be transferred to the firing platform without touching the unfired product application which is difficult to accomplish. When a large prosthesis like a bridge framework is being transferred it is even more difficult.

Existing firing trays cannot practicably be used as holders because current prosthesis wires do not provide a suitable mounting means to the tray to ensure stability especially with the narrow, pointed pins presently used for holding substructure for the prosthesis.

### SUMMARY OF THE INVENTION

The present invention provides advantages over the prior art. In accordance with one aspect of the present invention the firing platform is also the device that holds the prosthesis during preparation.

In accordance with another aspect of the present invention, there is no need to transfer the prosthesis from a dental holder to a new firing tray.

In accordance with another aspect of the present invention the pin system for supporting the prosthesis provides advantages by providing a good surface mounting area and configuration for stabilizing the prosthesis thereby saving time, facilitating applications of various porcelain layers or other ceramics, and avoiding balancing prostheses on fine pointed pins during the preparatory and firing steps.

The dental holder of the present invention facilitates the preparation of dental prostheses by reducing potential damage to the porcelain layers which may occur if the prosthesis falls or is dropped during preparation.

In accordance with another aspect of the present invention, the dental holder of the present invention facilitates the even application of porcelain, ceramics, or other coatings or treatments, by hand or by aerosol, by providing full access to the surface area of the dental prosthesis. When working on the prosthesis, the need to use tweezers or other tools to hold or transfer the prosthetic is avoided.

In accordance with another aspect of the present invention, the fine marginal edge of the prosthesis is maintained with good integrity and not damaged as would occur at times with the use of as tweezers or other devices.

In accordance with another aspect of the present invention external stresses, such as those which occur when using a tool that expands from the inside of the prosthesis and pushes outward, are avoided.

In accordance with another aspect of the present invention there is provided a stand alone dental holder firing platform, or tray, that does not require the repositioning, transfer or use of tools to move the prosthesis from a working platform to a new platform or tray for firing in a furnace.

In accordance with another aspect of the present invention there is provided a method for preparing a dental prosthesis using a dental holder that also serves as a firing platform.

In accordance with another aspect of the present invention there is provided at least one pin on at least one base for mounting a dental prosthesis or for mounting a substructure for preparing a dental prosthesis.

In accordance with another expect of the present invention more than one base can be linked or joined together using at least one connector such as linker or joining bars, or dowels, pins, hooks, springs, levers, or other equivalent means to connect more than one base together to accommodate lengthier bridge frameworks in groups either linearly or grouped together in other patterns.

In accordance with another aspect of the present invention there is provided an apparatus for holding a dental prosthesis during preparation of the dental prosthesis, the apparatus comprising:

at least one base, the at least one base having an upper surface,

at least one pin, the at least one pin comprising a first end and a second end,

the first end being flared and/or cup-shaped and extending beyond the upper surface of the at least one base, and

the second end extending through and into the upper surface of the base.

In accordance with another aspect of the present invention, the apparatus further comprises a recessed portion and a notch portion.

In accordance with another aspect of the present invention, the recessed portion is adapted to receive at least one connector.

In accordance with another aspect of the present invention, the notch portion is adapted to resist slippage of the connector from the recessed portion.

In accordance with another aspect of the present invention, the recessed portion is adapted to receive said connector.

In accordance with another aspect of the present invention, the recessed portion is a notch.

In accordance with another aspect of the present invention, at least two bases are joined together by means of at least one connector.

In accordance with another aspect of the present invention, at least one connector is a dowel and said dowel extends from said recessed portion of a first base to said recessed portion of a second base thereby connecting the two bases together in proximity one to the other.

In accordance with another aspect of the present invention, at least one pin is made of metal or plastic or a combination of metal and plastic parts.

In accordance with another aspect of the present invention, the apparatus comprises two pins in one base.

In accordance with another aspect of the present invention, the apparatus comprises four pins in one base.

In accordance with another aspect of the present invention, there is provided a use of an apparatus for holding a dental prosthesis during preparation of the prosthesis and for holding the dental prosthesis during firing without having to transfer the prosthesis to a second tray for firing.

In accordance with another aspect of the present invention, there is provided a method for preparing a dental prosthesis, the method comprising the steps of,

a) mounting a substructure on an apparatus according to claim 1,

b) applying at least one layer of ceramic to prepare a dental prosthesis, and

c) firing the prosthesis mounted on the apparatus in a furnace.

In accordance with another aspect of the present invention, the substructure is mounted on the flared first end of the pin.

In accordance with another aspect of the present invention, the substructure is mounted using glue.

In accordance with another aspect of the present invention, the substructure is either mounted by balancing or secured by suction forces between the substructure and the flared first end of the pin.

In accordance with another aspect of the present invention, there is provided a dental pin having a flared, cup-shaped end.

In accordance with another aspect of the present invention, the flared, cup-shaped end of the dental pin is an integral part of the pin.

In accordance with another aspect of the present invention, the flared, cup shaped end of the dental pin is a separate piece attached to one end of the pin.

In accordance with another aspect of the present invention, the dental pin further comprises a washer.

In accordance with another aspect of the present invention, the pin is made of metal or plastic or a combination of metal and plastic parts.

In accordance with another aspect of the present invention there is provided a washer connectable to or attached to the pin.

In accordance with another aspect of the present invention, there is provided a use of an apparatus for holding a dental prosthesis during preparation of the prosthesis and for also holding the dental prosthesis during firing without the need for transferring to another tray.

In accordance with another aspect of the present invention there is provided a method for preparing a dental prosthesis, the method comprising the steps of,
a) mounting a substructure on the dental holder platform apparatus of the present invention,
b) applying at least one layer of ceramic to prepare a dental prosthesis, and
c) firing the prosthesis mounted on the apparatus in a furnace.

In accordance with another aspect of the present invention there is provided a method wherein a substructure is mounted on a flared and/or cup-shaped first end of a pin.

In accordance with another aspect of the invention the substructure is mounted using glue.

In accordance with another aspect of the present invention the substructure is mounted by balancing.

In accordance with another aspect of the present invention, there is provided a dental pin having one flared and/or cup-shaped end. In a preferred embodiment the flared end is an integral part of the pin. In another embodiment the flared end is a separate piece that is attached or connectable to the end of the dental pin. In one embodiment the pin has a washer attached or connectable to the pin. In another embodiment the pin is washer less. In a third embodiment a washer is used which is separate from the pin.

### BRIEF DESCRIPTION OF DRAWINGS

Other and further advantages and features of the invention will be apparent to those skilled in the art from the following detailed description of the preferred embodiments of the invention taken together with the accompanying drawings.

For the purpose of illustrating the invention, there is shown in the drawings a form which is presently preferred; it being understood, however, that this invention is not limited to the precise arrangements and instrumentalities shown.

In the accompanying drawings:

FIG. 1 is a front perspective view of a single pin first variant of the dental prosthesis holder, with washer, illustrating the top of the article.

FIG. 2 is a rear perspective view of the variant of FIG. 1 illustrating the bottom of the article.

FIG. 3 is a left side elevation view of the variant of FIG. 1.

FIG. 4 is a front elevation view of the variant of FIG. 1.

FIG. 5 is a right side elevation view of the variant of FIG. 1.

FIG. 6 is a rear elevation view of the variant of FIG. 1.

FIG. 7 is a top plan view of the variant of FIG. 1.

FIG. 8 is a bottom plan view of the variant of FIG. 1.

FIG. 9 is a front perspective view of a two-pin second variant of the dental prosthesis holder, with washer, illustrating the top of the article.

FIG. 10 is a rear perspective view of the variant of FIG. 9 illustrating the bottom of the article.

FIG. 11 is a left side elevation view of the variant of FIG. 9.

FIG. 12 is a front elevation view of the variant of FIG. 9.

FIG. 13 is a right side elevation view of the variant of FIG. 9.

FIG. 14 is a rear elevation view of the variant of FIG. 9.

FIG. 15 is a top plan view of the variant of FIG. 9.

FIG. 16 is a bottom plan view of the variant of FIG. 9.

FIG. 17 is a front perspective view of a four-pin third variant of the dental prosthesis holder, with washer, illustrating the top of the article.

FIG. 18 is a rear perspective view of the variant of FIG. 17 illustrating the bottom of the article.

FIG. 19 is a left side elevation view of the variant of FIG. 17.

FIG. 20 is a front elevation view of the variant of FIG. 17.

FIG. 21 is a right side elevation view of the variant of FIG. 17.

FIG. 22 is a rear elevation view of the variant of FIG. 17.

FIG. 23 is a top plan view of the variant of FIG. 17.

FIG. 24 is a bottom plan view of the variant of FIG. 17.

FIG. 25 is a front perspective view of a single pin fourth variant of the dental prosthesis holder, without washer, illustrating the top of the article.

FIG. 26 is a rear perspective view of the variant of FIG. 25 illustrating the bottom of the article.

FIG. 27 is a left side elevation view of the variant of FIG. 25.

FIG. 28 is a front elevation view of the variant of FIG. 25.

FIG. 29 is a right side elevation view of the variant of FIG. 25.

FIG. 30 is a rear elevation view of the variant of FIG. 25.

FIG. 31 is a top plan view of the variant of FIG. 25.

FIG. 32 is a bottom plan view of the variant of FIG. 25.

FIG. 33 is a front perspective view of a two-pin fifth variant of the dental prosthesis holder, without washer, illustrating the top of the article.

FIG. 34 is a rear perspective view of the variant of FIG. 33 illustrating the bottom of the article.

FIG. 35 is a left side elevation view of the variant of FIG. 33.

FIG. 36 is a front elevation view of the variant of FIG. 33.

FIG. 37 is a right side elevation view of the variant of FIG. 33.

FIG. 38 is a rear elevation view of the variant of FIG. 33.

FIG. 39 is a top plan view of the variant of FIG. 33.

FIG. 40 is a bottom plan view of the variant of FIG. 33.

FIG. 41 is a front perspective view of a four-pin sixth variant of the dental prosthesis holder, without washer, illustrating the top of the article.

FIG. 42 is a rear perspective view of the variant of FIG. 41 illustrating the bottom of the article.

FIG. 43 is a left side elevation view of the variant of FIG. 41.

FIG. 44 is a front elevation view of the variant of FIG. 41.

FIG. 45 is a right side elevation view of the variant of FIG. 41.

FIG. 46 is a rear elevation view of the variant of FIG. 41.

FIG. 47 is a top plan view of the variant of FIG. 41.

FIG. 48 is a bottom plan view of the variant of FIG. 41.

FIG. 49 is a front perspective view of a pin for a dental prosthesis holder, with washer, illustrating the top of the article.

FIG. 50 is a rear perspective view of the pin of FIG. 49 illustrating the bottom of the article.

FIG. 51 is a side elevational view of the pin of FIG. 49.

FIG. 52 is a top plan view of the pin of FIG. 49.

FIG. 53 is a bottom plan view of the pin of FIG. 49.

FIG. 54 is a front perspective view of a pin for a dental prosthesis holder, with washer, illustrating the top of the article.

FIG. 55 is a rear perspective view of the pin of FIG. 54 illustrating the bottom of the article.

FIG. 56 is a side elevational view of the pin of FIG. 54.

FIG. 57 is a top plan view of the pin of FIG. 54.

FIG. 58 is a bottom plan view of the pin of FIG. 54.

FIG. 59 illustrates a perspective view of a combined dental holder firing platform of the present invention having a single pin and no washer,

FIG. 60 is a perspective view of a combined dental holder firing platform of the present invention having a single pin with a washer,

FIG. 61 illustrates a perspective view of a pin of the present invention having a washer attached thereto,

FIG. 62 illustrates a portion of the pin of the present invention to show one embodiment of the flared first end of the pin which is integral with the body of the pin,

FIG. 63 illustrates one embodiment of the dental holder of the present invention having two bases each with a single pin with a washer. As illustrated, the two bases are joined by a bar.

FIG. 64 illustrates one embodiment of the dental holder platform of the present invention having two bases and with a single pin with a washer, one with 4 pins having washers, joined by a bar.

FIG. 65 illustrates the embodiment of FIG. 64 having a prosthesis or bridge framework mounted on the pins and turned upside down,

FIG. 66 illustrates the embodiment of FIG. 64 having a prosthesis or bridge framework mounted on the pins and is illustrated right side up.

FIG. 67 illustrates an embodiment of the dental holder platform of the present invention having a single base with two pins having washer in the right side up position

FIG. 68 illustrates an embodiment of the dental holder platform of the present invention having a single base with two pins having washers, in the upside down position.

### DEFINITIONS

Dental Substructures: are the supporting frameworks for the porcelain layers which provide strength to the dental crown/bridge. Typically made of metals (precious metals like gold, platinum, palladium combinations or non precious metals or titanium), alumina, zirconium, or composite porcelains.
Coping: A substructure or bridge framework.

### DETAILED DESCRIPTION OF THE INVENTION

The apparatus device of the present invention is used to securely hold and fire a dental prosthesis from beginning to end of the dental prosthesis creation.

The dental holder of the present invention comprises a unique pin with a curved, cup shaped portion at one end. This shaped portion could also be described as flared or even “saucer” shaped. It is this curved, cupped shape is like a saucer at the end of the pin. While it would be possible to spot weld a “saucer” element to the end of a traditional pin, it is preferred that the pin be prepared such that this shape is an integral portion when the shape of the end of the at least one pin is an integral portion of the pin it would appear as illustrated in the Figures. The pin and cup portion can be made of any suitable material as known to a person skilled in the art including materials such as plastic, aluminum and stainless steel.

The holder comprises one or more of the inventive pins of the present invention arranged on one or more bases.

Having the flared cupped ends allows the prosthesis to balance more easily and provides a place for securing or mounting the prosthesis to the pin in a more stable way. If glue is used, the flared cup provides a receptacle to receive the glue. In the instance where the cup and pin are integral the center of the pin could in one embodiment be filled with glue. This provides a place for the glue to stay until it has time to set/cure. In turn, this holds the prosthesis securely while the porcelain product (particularly liners, opaceous dentins and internal stains) are being applied.

The invention provides these advantages:
a. don't need to transfer the prosthesis to a firing stand after porcelain has been applied which
avoids potential damage of the applied porcelain product due to falling/dropping (before porcelain is baked it is very easily damaged.)
allows for easier, 360 even application of porcelain as don't need to move tweezer/hemostate to cover that area
saves time and frustration.
b. does not damage the fine marginal edge of the prosthesis as tweezers which are used as a popular holder, may.
c. no application of external stress from using a tool to hold the prosthesis that expands from the inside and pushes outward (when using this tool it is extremely difficult to transfer to firing tray).

In the manufacturing of dental prostheses the application of porcelains and related products are applied over a substructure called a coping or bridge framework or built up as a stand-alone porcelain. The prosthesis must be held by a device while theses products are being applied and then once the porcelain product layers have been applied the coping is transferred to a firing tray which in turn is placed into a porcelain furnace. It is imperative that the layers of product be applied evenly to achieve optimum results.

The porcelain and porcelain related materials are placed in a porcelain furnace (like a small kiln) and fired after each layering application. There are multiple firings of each ‘layer’ to create a finished prosthesis, such as a dental crown or bridge. Therefore there are multiple instances when the delicate dental prosthesis must be handled and transferred. Prior to firing the material is wet and would be damaged if touched. Therefore it is very difficult at present, using prior art methods and tools, to transfer to a firing tray.

This invention relates to a combined dental holder and firing platform. It is used to securely hold a dental prosthesis during the application of porcelain and porcelain related products and it can also be used for the firing steps. It consists of a base which has one or more fine metal pins (approx. diameter 1 mm.) extending out of the base. The ends of the pins are flared or cupped to hold a drop of glue. Preferred glues are commercially prepared glues specific glues which are most preferred are “Crazyglue”™ or types of glues containing ethyl 2 cyanoacrylate. Balance the prosthesis until the glue has set.

When balancing bridge frameworks the base of the holder/firing tray of the present invention is glued in place by using a narrow bar of the same material as the base material thereby stabilizing both pins in the desired position. Various arrangements of the pins in bases, and various arrangements of bases may be configured to accommodate all lengths and types of bridge frameworks. Multiple supports could be used for longer prostheses by extending the bar to make it longer so that a line of trays be connected. Alternatively, multiple bars could be used to connect bases. The porcelain and porcelain related products are applied evenly and the prosthesis remains secure on the holder/firing tray without risk of falling (which will damage the fragile porcelain layers), unlike previous systems which require you to transfer from the holding device to a firing tray.

When a large prosthesis like a bridge framework is being transferred it is even more difficult. In the prior art other products currently available are used to hold the crown/bridge/prosthesis while it is fired in a porcelain furnace. The disadvantage is that the coping must be transferred to this platform without touching the unfired product application.

One of the advantages of this new firing platform is that it also becomes the device used to hold the crown.

Gluing the prosthesis to an existing, prior art, firing tray is not practical as the wire on which the prosthesis is balanced is too fine to hold the drop of glue therefore a splayed or cupped tip is necessary.

When preparing a dental prosthesis such as a crown or a bridge the preparation includes several steps for porcelain application. Although the order may vary, the order that the porcelain applications (typically ceramics) are applied, over a substructure, is as follows:
1. Liner or opaque layer (sometimes there are multiple applications at this stage ie. the layer is applied then fired, then re-applied and fired in a furnace 2-3 times until the desired effect of masking the color of the substructure is obtained)
2. Internal staining or porcelain modifier
3. Opacious Dentin porcelain
4. Dentin porcelain
5. Enamel or luster porcelain layer
6. Surface staining
7. Glaze (also available in an aerosol spray)

A great advantage of the present invention apparatus, holder, pin and methods are in steps 1, 2, 6, and 7. In some instances the user may not necessarily use glue on the flared or cup-shaped end(s) of the pin(s) but the cupped end(s) still provide a greater balancing stability for the bridge.

When applying the layers, the whole substructure surface must be covered. For example in step 1 with the liner/opaque product to block out the color of the substructure. It is extremely important to apply this evenly. It is a sticky, runny material that in the past has been applied with a brush. There are new products on the market that are now applying the liner/opaque layer with an aerosol spray.

The use of an aerosol spray rather than brushing the glaze to the surface is becoming increasingly popular.

The holder platform of the present invention provides important advantages in step 1. s Using the holder platform of the present invention the substructure would be balanced and secured (for example, glued) on the holder and the aerosol application would be applied very quickly and very prior to placing it evenly into the furnace. You don't have to hold or touch the coping with a tweezer or other device and then carefully balance it on a pin and place it in the furnace as is done in the prior art. The time saving factor and ease of application are distinct advantages. A further advantage of the pin of the present invention is that it provided enhanced stability over other prior art systems in which the prostheses are balanced on the fine pointed pins as the force of the aerosol may be too strong and cause the pins to fall off the pegs.

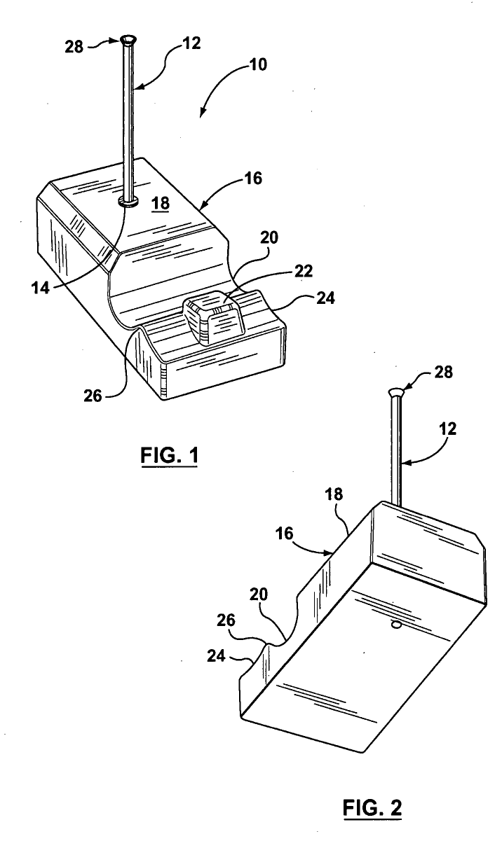

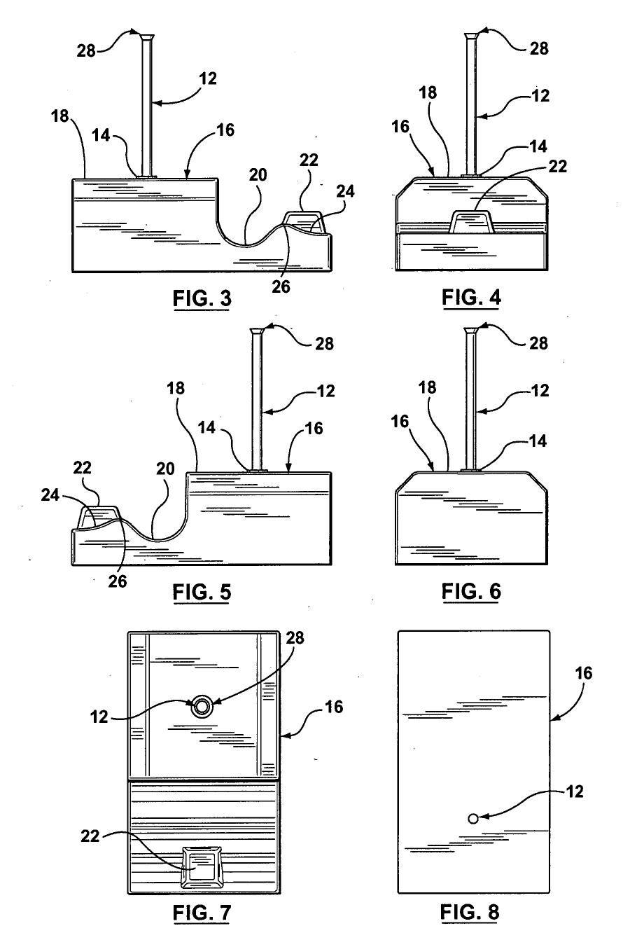

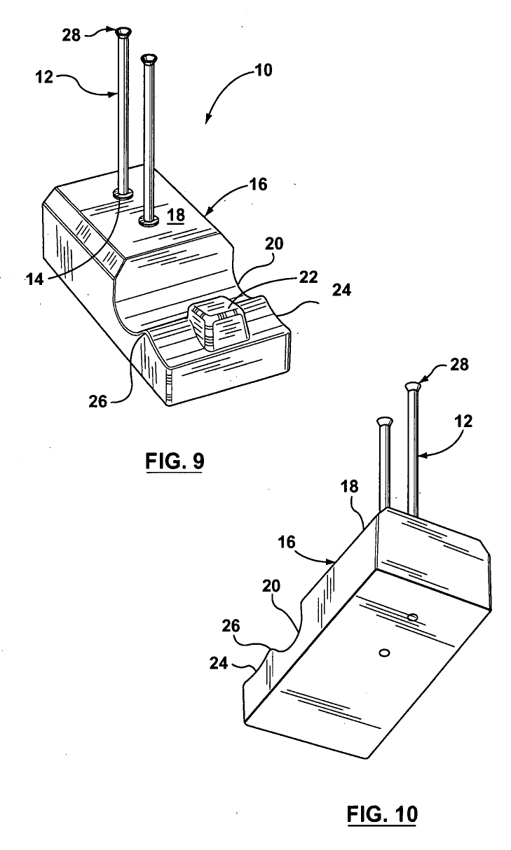

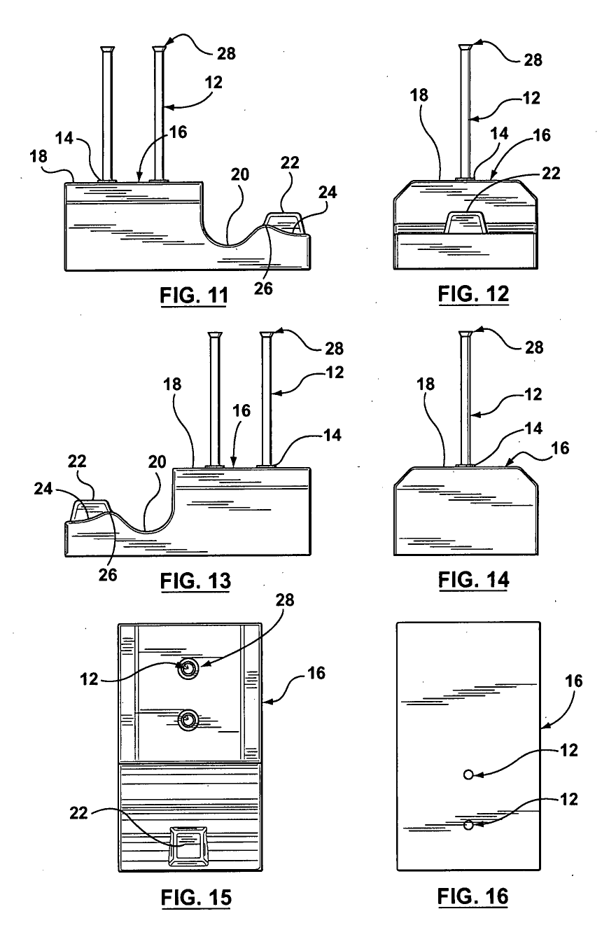

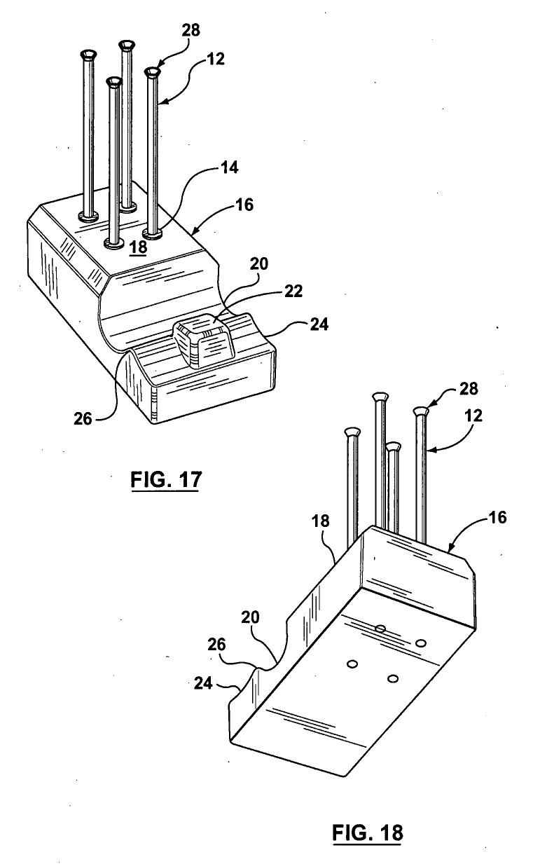

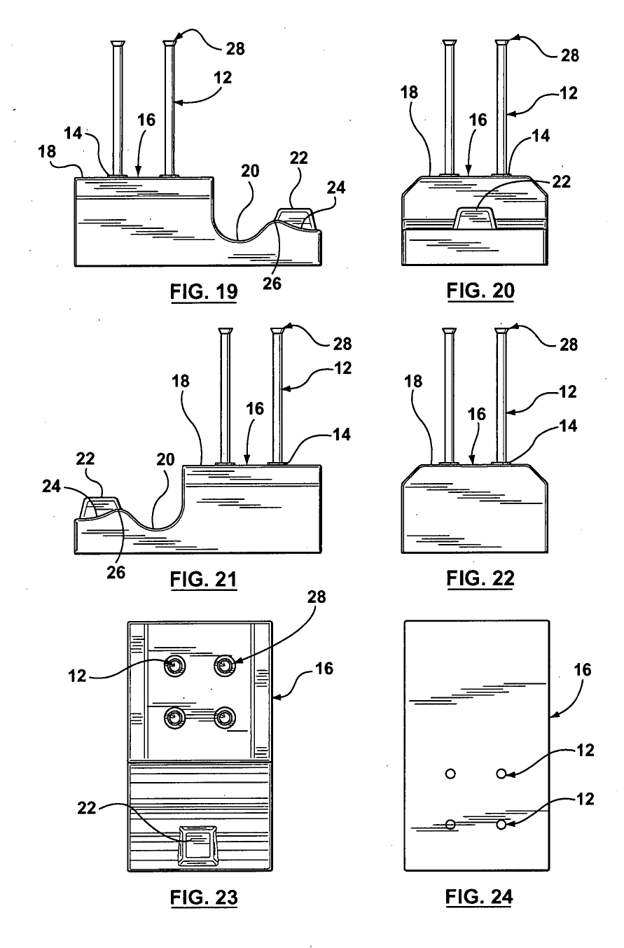

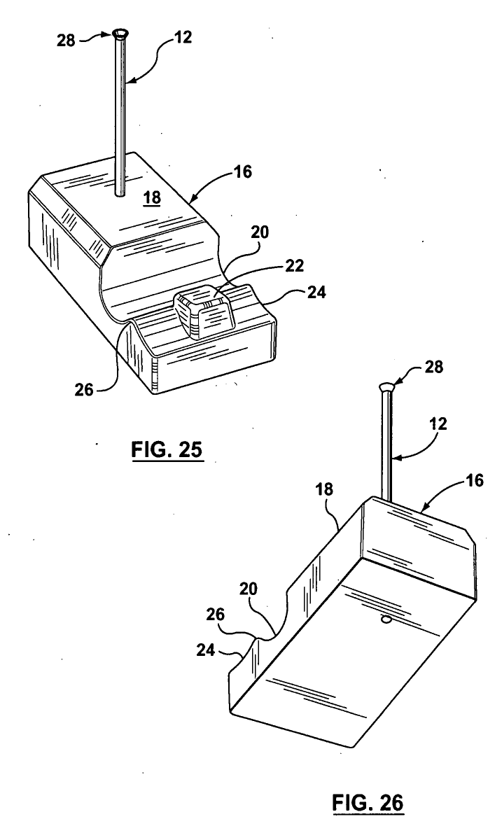

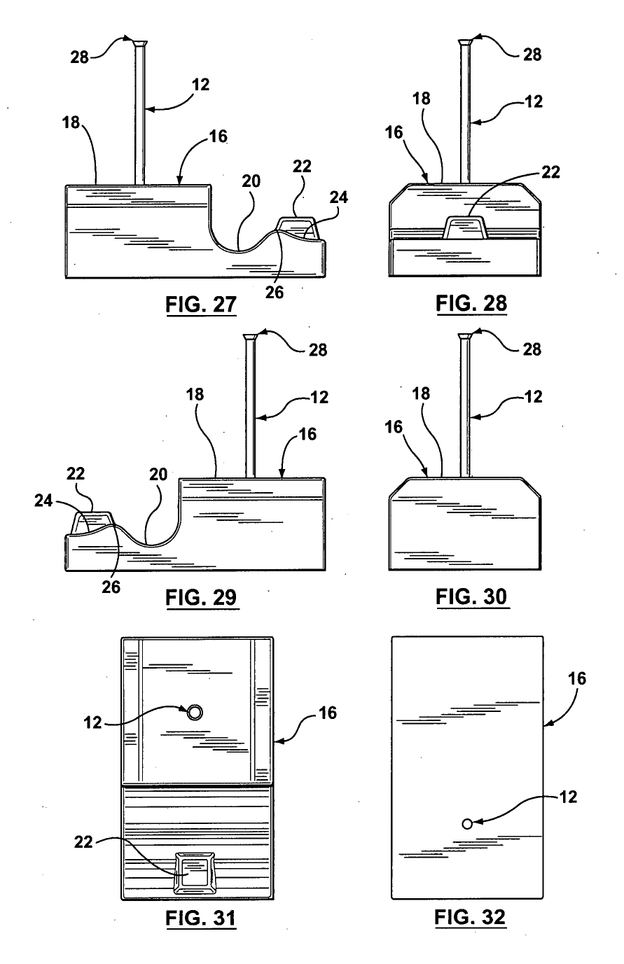

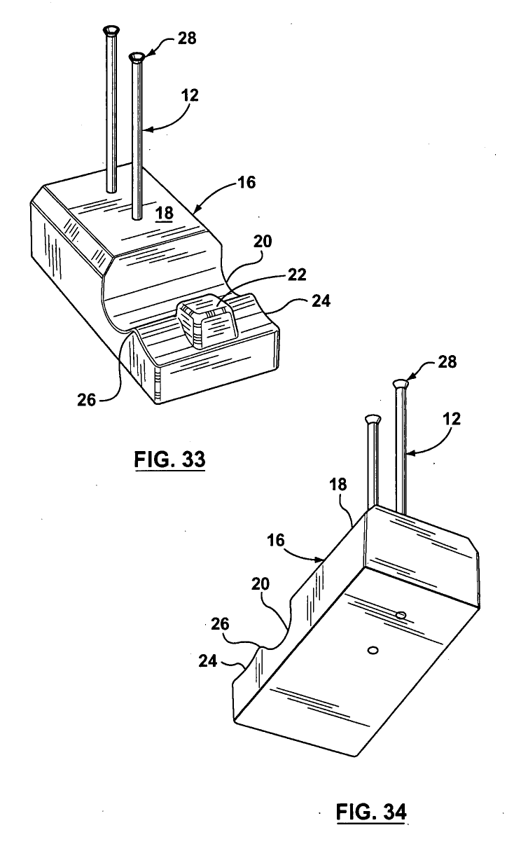

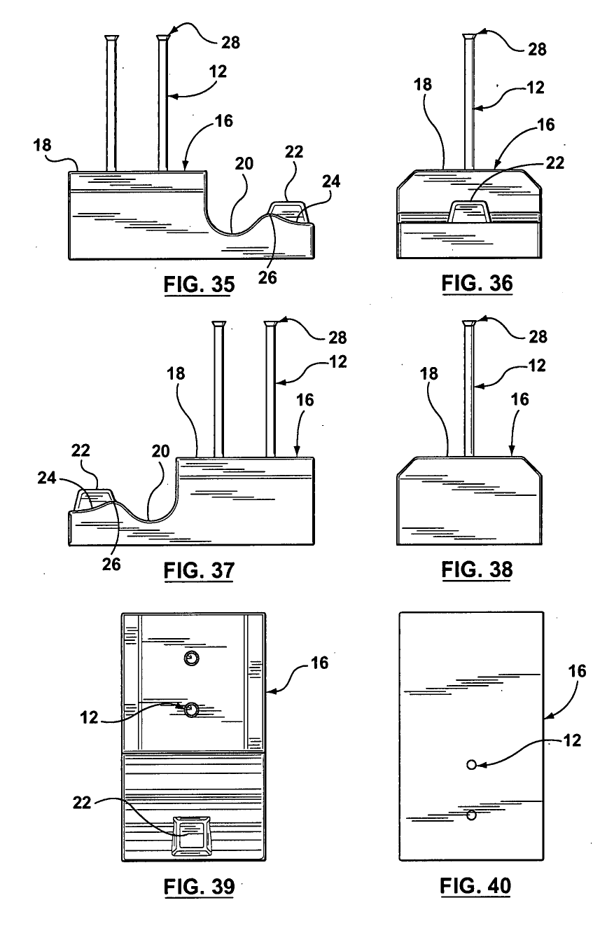

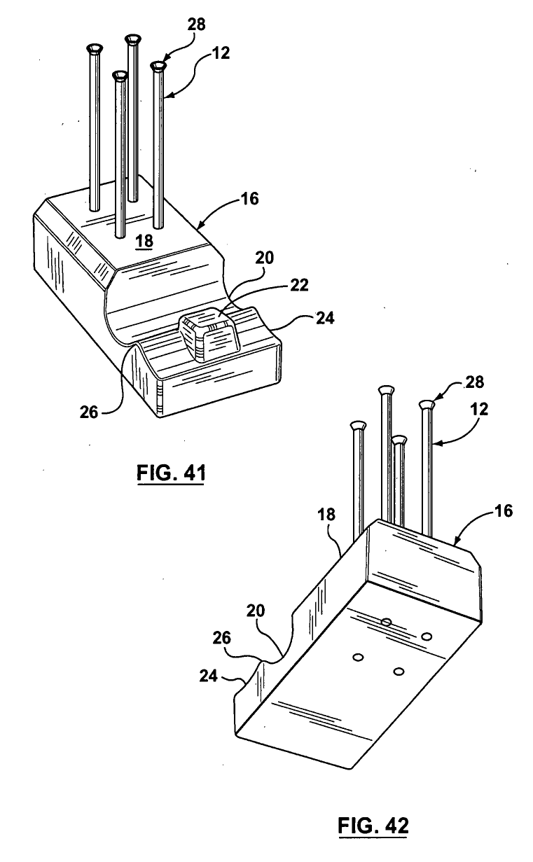

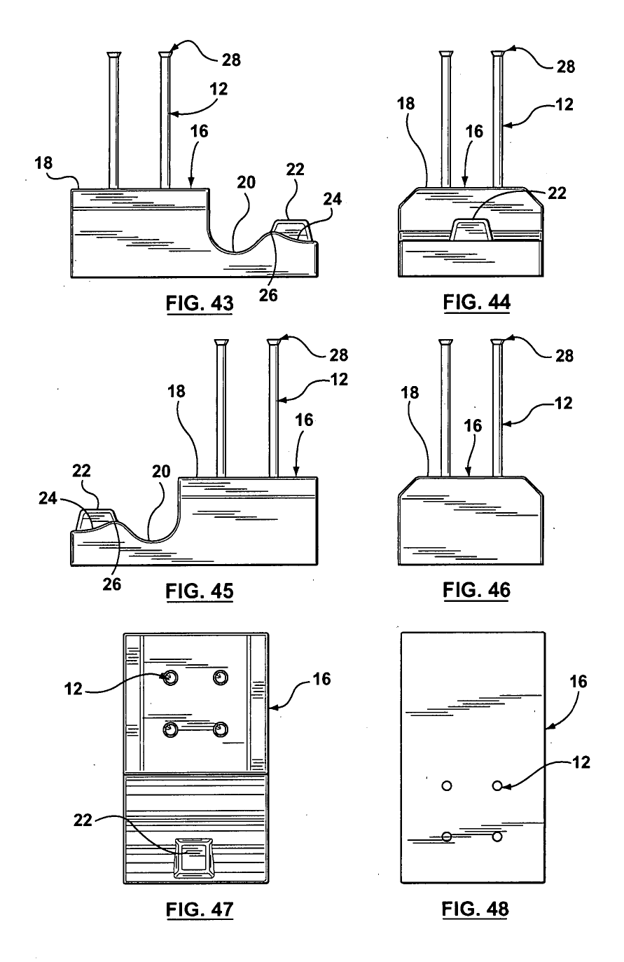

Turning to the Figures, a dental holder 10 (FIG. 1) is provided having a pin 12. The pin may optionally have a washer 14. The washer may be spot welded to the pin 12 or sold separately and then joined to the pin 12. The washer 14 attached to the pin 12 helps to stabilize the pin 12 in the base 16. The pin 12 is inserted into the upper surface 18 of the base 16.

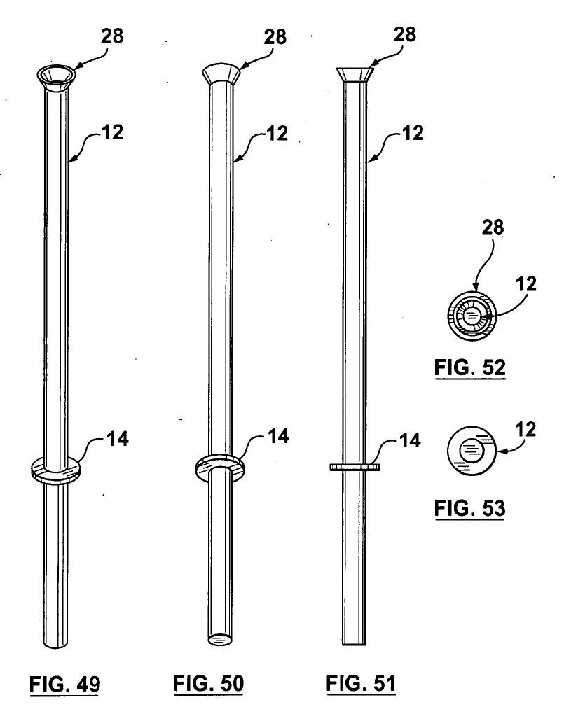

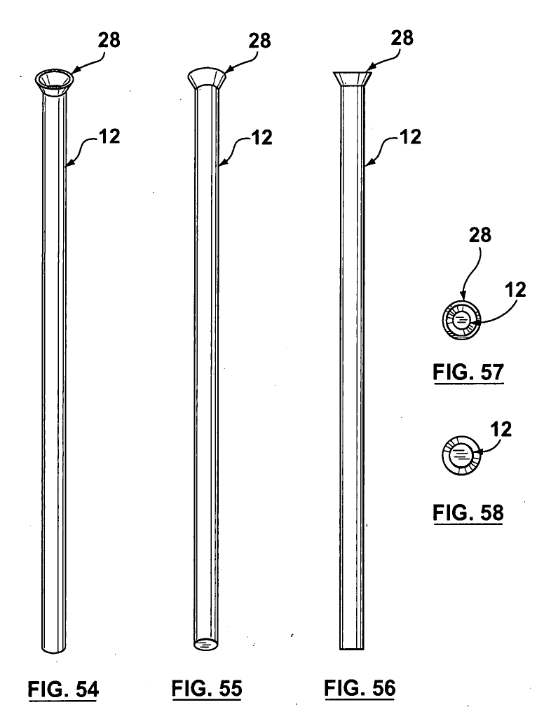

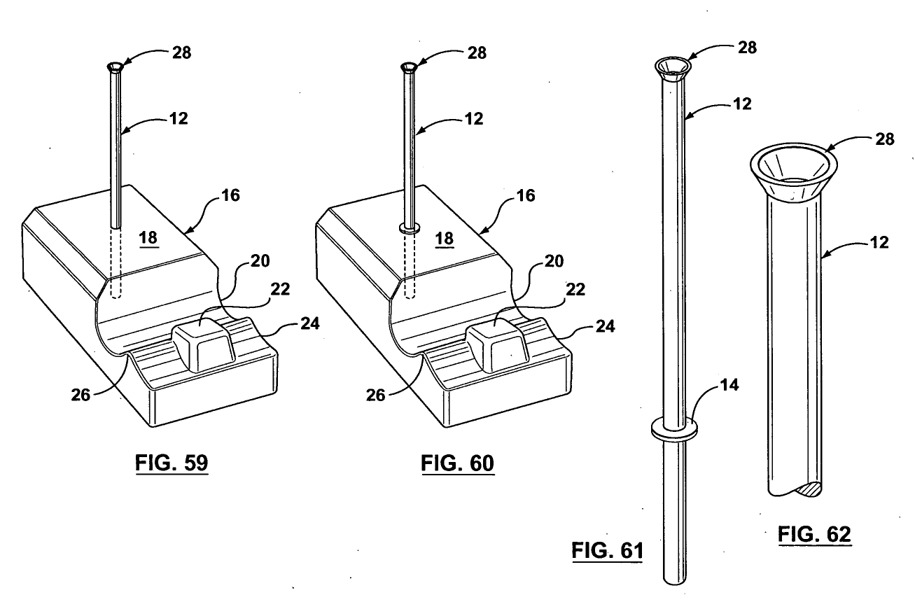

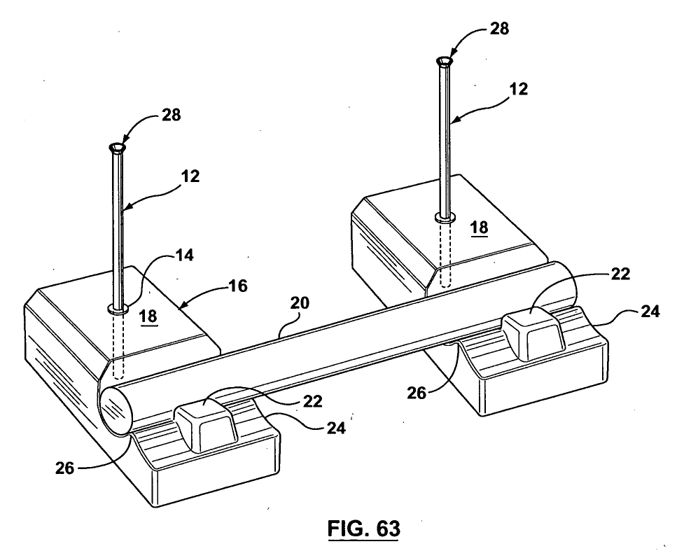

The pin alone is illustrated in FIGS. 49 to 53 with a washer and in FIGS. 54 to 58 without a washer.

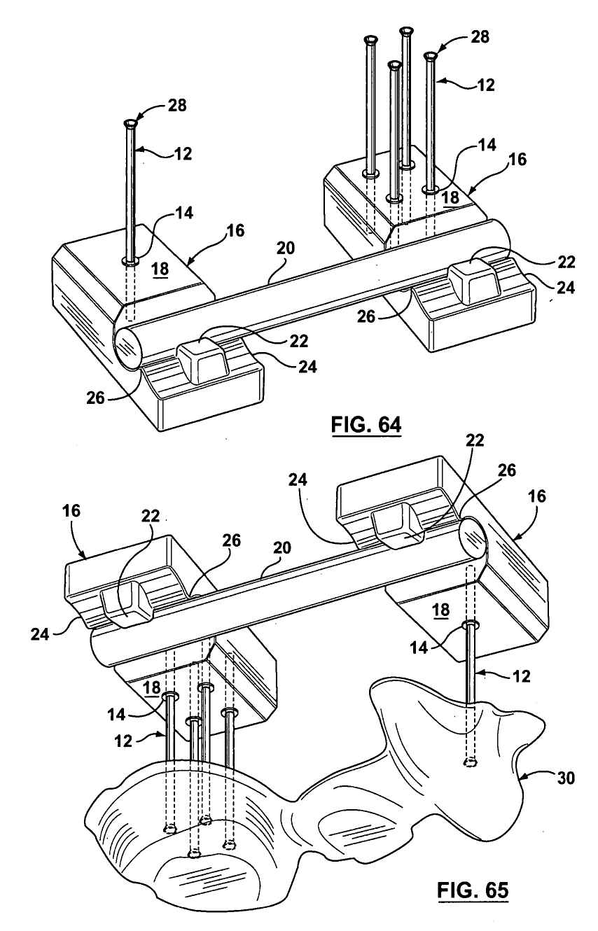

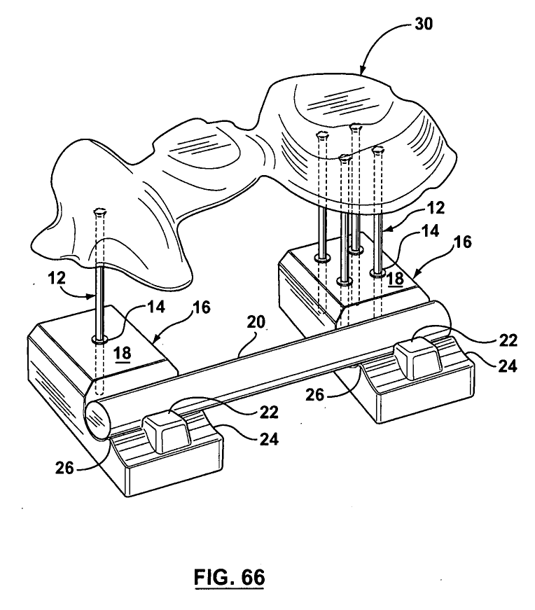

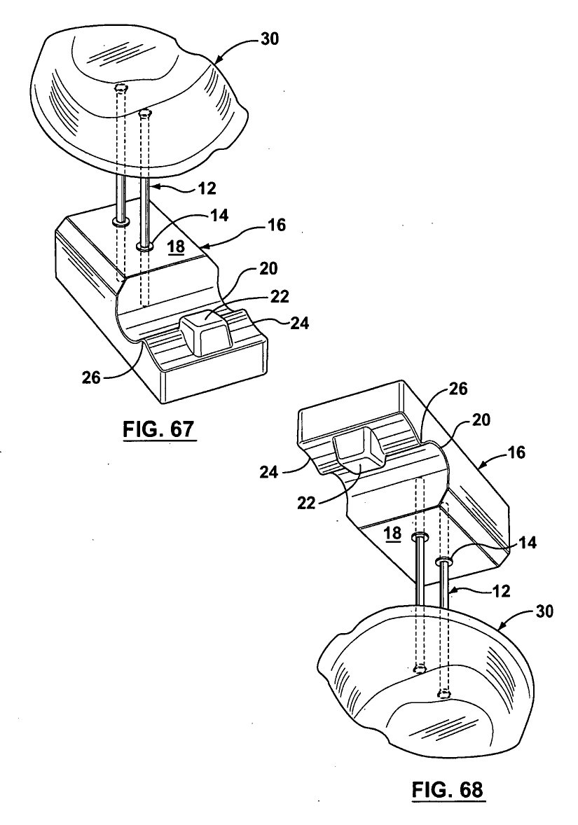

In FIG. 1, base 16 is adapted by providing a curved recessed portion 20 to receive the linker or joining bar 18 as illustrated in FIGS. 63 to 66.

The base 16 may optionally be shaped to receive a connector means. The connector means may be a linking bar or joining bar or a dowel 18 illustrated in FIGS. 63 to 66. The connector means may also be pins, springs, levers, or other equivalent means to connect more than one base together.

In a preferred embodiment a raised notch element 22 is provided on the leading front tongue 24 of the base 16 and this element acts to secure the bar 18 in place. It is not necessary, although it is preferred, to have the notch element 22 to secure the bar 18 as the recess 20 has a leading ridge 26 which also serves to hold the bar 18 in position.

Although configurations with two bases are illustrated herein, additional bases could be linked together to form longer dental holder platforms of the present invention.

The flared cup portion 28 at the one end of the dental pin 12 is adapted by way of the flaring which creates a force, for example, a suction force, to secure the dental prosthesis 30 so it does not fall off even when turned upside down (FIGS. 65 and 68).

Although preferred embodiments of the invention have been described herein, it will be understood by those skilled in the art that variations, modifications and equivalents may be made without departing from the spirit or scope of the invention as defined in the appended claims.

What is claimed is:

1. An apparatus for holding a dental prosthesis during preparation of the dental prosthesis, the apparatus comprising:
at least one base, said at least one base having an upper surface,
at least one pin, said at least one pin comprising a first end and a second end,
said at least one pin further comprising a flared portion at said first end.
said first end extending beyond said upper surface of said at least one base,
and said second end extending through and into said upper surface of said base.

2. The apparatus according to claim 1 wherein said apparatus further comprises a recessed portion and a notch portion.

3. The apparatus according to claim 2 wherein said recessed portion is adapted to receive at least one connector.

4. The apparatus according to claim 3 wherein said notch portion is adapted to resist slippage of the connector from the recessed portion.

5. The apparatus according to claim 4 wherein the recessed portion is adapted to receive said connector.

6. The apparatus according to claim 5 wherein the recessed portion is a notch.

7. The apparatus according to claim 4 wherein at least two bases are joined together by means of at least one connector.

8. The apparatus according to claim 7 wherein said at least one connector is a dowel and said dowel extends from said recessed portion of a first base to said recessed portion of a second base thereby connecting the two bases together in proximity one to the other.

9. The apparatus according to claim 7 wherein said at least one pin is made of metal or plastic or a combination of metal and plastic parts.

10. The apparatus according to claim 9 wherein said apparatus comprises two pins in one base.

11. The apparatus according to claim 9 wherein said apparatus comprises four pins in one base.

12. The use of an apparatus according to claim 1 for holding a dental prosthesis during preparation of said prosthesis and for holding said dental prosthesis during firing without having to transfer the prosthesis to a second tray for firing.

13. A method for preparing a dental prosthesis, said method comprising the steps of,
a) mounting a substructure on an apparatus according to claim 1,
b) applying at least one layer of ceramic to prepare a dental prosthesis, and
c) firing said prosthesis mounted on said apparatus in a furnace.

14. A method according to claim 13 wherein said substructure is mounted on said flared first end of said pin.

15. A method according to claim 14 wherein said substructure is mounted using glue.

16. A method according to claim 14 wherein said substructure is either mounted by balancing or secured by suction forces between the substructure and the flared first end of said pin.

17. A dental pin having a flared, cup-shaped end.

18. The dental pin according to claim 17 wherein the flared, cup-shaped end is an integral part of said pin.

19. The dental pin according to claim 9 wherein the flared, cup shaped end is a separate piece attached to one end of said pin.

20. The dental pin according to claim 17 further comprising a washer.

21. The dental pin according to claim 17 wherein the pin is made of metal or plastic or a combination of metal and plastic parts.
